(19) United States
(12) Patent Application Publication
(10) Pub. No.: US 2015/0290958 A1
(43) Pub. Date: Oct. 15, 2015

(54) SECURE CARD CUSTOMISABLE BY THERMAL TRANSFER PRINTING

(71) Applicant: ARJOWIGGINS SECURITY, Boulogne Billancourt (FR)

(72) Inventors: Alice Genet, La Buisse (FR); Thibaut Le Loarer, Pommier De Beaurepaire (FR); Fabien Margier, Beaurepaire (FR)

(73) Assignee: ARJOWIGGINS SECURITY, Boulogne Billancourt (FR)

(21) Appl. No.: 14/439,659

(22) PCT Filed: Oct. 31, 2013
(86) PCT No.: PCT/IB2013/059815

§ 371 Date: Apr. 29, 2015

(30) Foreign Application Priority Data
Oct. 31, 2012 (FR) 1260429

(51) Int. Cl. B41M 5/035; B41M 5/52; B42D 25/21; G06K 19/077; B32B 27/10; B32B 7/12; B32B 37/00; B41M 5/025; B42D 25/47

(52) U.S. Cl. CPC B41M 5/0355; B41M 5/0256; B41M 5/5254; B42D 25/21; B42D 25/47; B32B 27/10; B32B 7/12; B32B 37/025; G06K 19/0772; G06K 19/07749; B42D 2033/28; B42D 2033/30; B32B 2425/00; B32B 2519/02; B32B 2255/12

(57) ABSTRACT

A structure that is customizable by thermal transfer printing, in particular D2T2 or re-transfer, in particular for a multi-layer secure card structure, may include a layer of a non-opaque material for receiving thermal transfer printing, preferably comprising a vinyl polymer, in particular non-halogenated, better still a polyvinyl ester, and more preferably still polyvinyl acetate (PVAc); and a fibrous paper sub-layer, comprising at least one security element incorporated into the paper and/or arranged on the surface of the fibrous sub-layer.

The present invention relates to the field of documents with a multilayer structure, in particular documents of the secure card type, optionally having a contact or contactless or contact and contactless (dual interface) communication system, or any other document with a multilayer structure.

The term “card” denotes a multilayer structure coated on at least one face with a plastic. It may be an identity card, a social security card, a driver's license, an access card, a border crossing card, a playing card, a means of payment, a gift token or a voucher, a travel pass, a membership card, etc.

### BACKGROUND

Most known cards are conventionally made of a card body coated on both opposing faces with transparent PVC (polyvinyl chloride) or PC (polycarbonate) layers.

Varying information is printed using a thermal transfer printing technique termed “D2T2” (dye diffusion thermal transfer) or using a “re-transfer” technique.

The re-transfer technique consists in first printing a printing pattern backwards on the back of a re-transfer film. The printing is deposited by thermal sublimation. This re-transfer film is then placed on a receiving structure, on which the printing pattern must appear, with application of pressure and heat. The re-transfer film with the printing pattern remains on said structure and then constitutes a film protecting the printing.

The re-transfer printing technique can be carried out in particular on a DNP CX-330 machine from the company Dai Nippon Printing.

The re-transfer printing technique has the advantage of providing good results whatever the roughness of the receiving structure, of making it possible to cover the entire surface of said structure with printing, without non-printed areas due to a margin on the edges, and of protecting the printing.

The D2T2 and re-transfer printing techniques have in common the fact that they involve a sublimable ink and the formation of a printing pattern by application of heat and pressure.

As explained in the publication WO 2006/104857, the card body may be pre-printed and laminated with a transparent polycarbonate, PVC or polyester material. It is indicated in this publication that the layers for receiving the D2T2 printing are usually made of polyester, PVC or polycaprolactone. These polymers may be applied in solution in a solvent or by extrusion. This publication relates more particularly to the formulation of an intermediate layer located between the layer for receiving the printing and the card body.

U.S. Pat. No. 4,990,486 A mentions various supports for receiving thermal transfer printing, such as papers coated with polyethylene on both their faces.

U.S. Pat. No. 6,066,594 A describes security documents suitable for D2T2 printing. The body of the card is preferentially made of Teslin®, namely a nonfibrous material based on silica-filled polyolefin. The layer for receiving D2T2 printing is polyester-based.

The publications WO 2004/104779A2 and US 2005/0035590 describe security documents with a layer for receiving D2T2 printing made of PVC, covering a layer of PC or PET (polyethylene terephthalate).

Application GB 2 311 075 A describes a composition of a layer for D2T2 printing.

Publications WO 2006/104857 A2 and WO 2009/106036 A2 disclose PVC-based substrates for D2T2 printing.

Application WO 2009/007659 A2 describes a fibrous support termed “AWSLA” which is suitable for producing a card but which is not D2T2 printable.

Application WO 2012/014112 A1 discloses a card comprising a fibrous support termed “AWCEL” having good offset and inkjet printability characteristics, but which is not D2T2 printable, since it has a relatively rough surface not chemically suitable for receiving ink. If AWCEL paper is D2T2-printed in black, the black resembles gray and the printing is not clear.

Document JP2012/106485 describes a vinyl chloride resin latex for a thermal sublimation transfer image receiving sheet.

Document EP 1 174 278 teaches a paper support covered with a recording layer.

Document EP 1 457 320 discloses an information support in the format of a card comprising thermal transfer printing.

### SUMMARY

There is a need to further improve supports for D2T2 or re-transfer printing, and more particularly but not exclusively those intended for multilayer structures and in particular for cards that are customizable by D2T2 printing or by re-transfer, having security characteristics.

The invention satisfies this need by virtue of a structure that is customizable by thermal transfer printing (in particular D2T2 and more generally any other technique involving a sublimable ink and a printing pattern formed by application of heat and pressure, such as re-transfer), in particular for a multilayer structure of secure card type, the customizable structure comprising:
a layer of a non-opaque, preferably transparent, material for receiving thermal transfer printing, preferably comprising a vinyl polymer, which is in particular nonhalogenated, better still a polyvinyl ester, more preferably polyvinyl acetate (PVAc),
a fibrous paper sublayer, comprising at least one security element integrated into the paper and/or placed at the surface of the fibrous sublayer.

A subject of the invention is also a customizable structure, in particular for a multilayer structure, in particular a secure card, the customization being carried out by thermal transfer printing, in particular D2T2 or re-transfer, the customizable structure comprising:
a layer of non-opaque, preferably transparent, material for receiving thermal transfer printing, preferably comprising a vinyl polymer, which is in particular nonhalogenated, better still a polyvinyl ester, more preferably a polyvinyl acetate (PVAc),
a fibrous paper sublayer, having received in the fluid state the layer for receiving printing, and preferably comprising a security element integrated into the paper and/or placed on the surface of the fibrous sublayer.

A subject of the invention is also a multilayer structure, in particular of secure card type, comprising a customizable structure according to the invention and a multilayer structure body to which the customizable structure according to the invention is attached.

The paper sublayer may be in direct contact with the ink-receiving layer. The paper sublayer may also be in contact with offset printing which is in contact with the layer for receiving printing. Thus, the paper sublayer may either be in direct contact with the ink-receiving layer, or be printed, in particular by offset, laser toner or inkjet printing.

The layer for receiving printing may in particular be applied by coating in the fluid state, in particular in an aqueous solution, on the sublayer for receiving printing, and may penetrate through its thickness for example over a depth of about 1 to 15 μm. The layer for receiving printing may thus be different than a solid film preexisting before it is deposited onto the fibrous sublayer, which would be laminated thereon. The receiving layer is preferably in the liquid state during its application to the fibrous sublayer, of which it at least partially covers the surface, that it may thus “impregnate” through at least a part of its thickness by penetrating between the fibers.

The layer for receiving printing is compatible with D2T2 or re-transfer printing. The invention allows the re-transfer film to adhere well to the customizable structure.

The layer for receiving printing may be suitably printed on the D2T2 machines available on the market, for example of the brand names Evolis or HID.

The multilayer structure does not cause jamming of the printer, the ribbon does not break during printing and the printing of the characters is clear even for characters of a small size.

Furthermore, the black flat tint is uniform, the printing of a QR code or of a barcode is readable by an appropriate reader and the optical density of the black may be greater than or equal to 1.85.

The invention makes it possible to make the multilayer structure secure by means of the securing mechanisms known in the security paper field, the layer for receiving the printing revealing the security element(s) placed in the paper sublayer.

The invention also makes it possible to have a multilayer structure which is homogeneous from a mechanical point of view insofar as the mechanical properties of the paper sublayer coated with the layer for receiving printing are, overall, similar to those of a plastic of PVC or PETg type, in particular in terms of flexibility, extension and stiffness.

The customizable structure may be laminated with the body of the multilayer structure in a plate press (for example a Burkle press) under standard conditions for lamination of a PVC (120° C., 10 min) or of a polycarbonate (160° C., 30 min), without the customizable structure deteriorating or adhering to the lamination plates.

The invention also makes it possible to reduce the share of plastic in the multilayer structure, making it possible to obtain a product that is more easily recyclable.

Another advantage of the invention is that of making it possible to offset print a secure background on the paper sublayer while at the same time being able to customize the final multilayer structure by monochrome (in black or in color) or polychrome D2T2 printing. The invention makes it possible to combine at the same time the secure offset printability characteristics, the mechanical characteristics of “AWSLA” and “AWCEL” papers and customization by D2T2 printing.

The terms “color” and “colored” according to the invention include the whole of the visible spectrum.

The layer for receiving printing preferably comprises between 70% and 95% by weight of vinyl polymer, in particular of polyvinyl ester, better still of polyvinyl acetate, even better still between 80% and 90% by weight of polyvinyl ester, in particular of polyvinyl acetate. The layer for receiving printing may be free of polyolefin. In particular, the layer for receiving printing according to the invention may be different than a PE (polyethylene) film and than a polyester film. In the case where the layer for receiving printing comprises an inorganic filler, for example silica, in particular for improving printability, the layer for receiving printing preferably comprises between 40% and 80% by weight of vinyl polymer, in particular of polyvinyl ester, better still of polyvinyl acetate, even better still between 50% and 70% by weight of polyvinyl ester, in particular of polyvinyl acetate.

Unless otherwise indicated, the percentages are by dry weight relative to the total on a dry basis.

The layer for receiving printing is preferably present in an amount of between 5 and 30 g/m², better still between 10 and 20 g/m².

The layer for receiving printing preferably comprises a release agent for reducing the risk of adhesion to the surface used to exert the pressure required for the assembly with the body of the multilayer structure, preferably in a content of 5% to 30% by weight, better still 10% to 20% by weight, relative to the total dry weight of the layer. Unless otherwise indicated, the percentages are by dry weight relative to the total on a dry basis.

The layer for receiving printing may comprise between 85 and 115 parts (by weight) of vinyl polymer, in particular of polyvinyl ester, better still of polyvinyl acetate, even better still between 90 and 110 parts of polyvinyl ester, in particular of polyvinyl acetate, and a release agent, in a content of 15 to 40 parts, preferably 25 to 35 parts.

Unless otherwise indicated, the parts according to the invention are dry parts relative to the total on a dry basis.

The customizable structure may be provided with the layer for receiving printing already printed by thermal transfer, in particular D2T2 or re-transfer.

The paper sublayer may advantageously comprise a reagent which produces a colored reaction in the presence of an organic solvent, in particular of a ketone, in particular of acetone, this reagent being, for example, nigrosine black.

The paper sublayer preferably comprises an inorganic filler, which may improve the offset printability. The filler may be added in bulk or by coating during the production of the paper sublayer, it being, for example, silica, sodium aluminosilicate, calcium carbonate or kaolin, or a mixture thereof. Calcium carbonate is preferred to kaolin.

The paper sublayer may comprise synthetic fibers.

The paper sublayer may comprise a binder, in particular an acrylic latex, and a softener such as a urea/nitrate mixture.

The presence of synthetic fibers, of an acrylic binder and of a softener makes it possible to obtain a customizable structure with very good elasticity, flexibility and double folding endurance properties.

The paper sublayer may comprise a security element chosen from luminescent agents, in particular UV fluorescent agents, in particular in the form of fibers and/or of pigment. The paper sublayer may also comprise a magnetic security element.

The thickness of the multilayer structure is for example equal to 760 μm plus or minus 80 μm or, in other words, between 680 and 840 μm.

The layer for receiving printing may be covered with a protective film. The latter may carry a diffractive structure, in particular a hologram.

The multilayer structure may comprise an adhesive layer between the body of the multilayer structure and the customizable structure. This adhesive may be chosen from heat-activated adhesives.

The body of the multilayer structure may also comprise one or more layers of paper.

The body of the multilayer structure may also comprise an electronic chip, in particular an RFID chip.

A subject of the invention is also a card comprising the multilayer structure considered according to the invention. The card may be of identity card, social security card, driver's license, access card, border crossing card, loyalty card, playing card, means of payment, gift token or voucher, travel pass or membership card type.

A subject of the invention is also a process for producing a multilayer customizable structure according to the invention, wherein the structure that is customizable by thermal transfer printing (in particular D2T2 or re-transfer printing) is produced by depositing, in the fluid state, the layer for receiving printing on the paper sublayer.

The depositing of the layer for receiving printing may be carried out online, in particular by means of a coating technique, such as air-knife, reverse roll or roll flex coating, or offline, in particular by Champion, roll flex (transfer roll), reverse roll or air-knife coating or by means of a printing technique, in particular by photogravure, screen printing or flexography. The layer for receiving printing is then dried after deposition.

The layer for receiving printing is preferably formulated as an aqueous base.

The customizable structure may be hot-laminated on a card body, in particular at a temperature greater than or equal to 100° C.

The customizable structure may be covered with a removable release film during lamination thereof with the card body. This film may avoid any risk of adhesion of the customizable structure with the surface used for the assembly with the card body. The presence within the layer for receiving printing of a release agent may make it possible to avoid the use of such a release film.

The customizable structure may be covered with a release film during lamination thereof with a body of multilayer structure.

The paper sublayer may be printed by offset printing before receiving the layer for receiving thermal transfer printing.

The layer for receiving printing may be printed by thermal transfer, in particular with a black or colored monochrome ink or with polychrome inks.

A subject of the invention is also an assembly comprising a customizable structure according to the invention and printing, obtained in particular by D2T2 or re-transfer, covering the layer for receiving printing.

A subject of the invention is also an assembly comprising a multilayer structure according to the invention and printing, obtained in particular by D2T2 or re-transfer, covering the layer for receiving printing.

Customizable Structure (Termed “PCPP” Substrate)

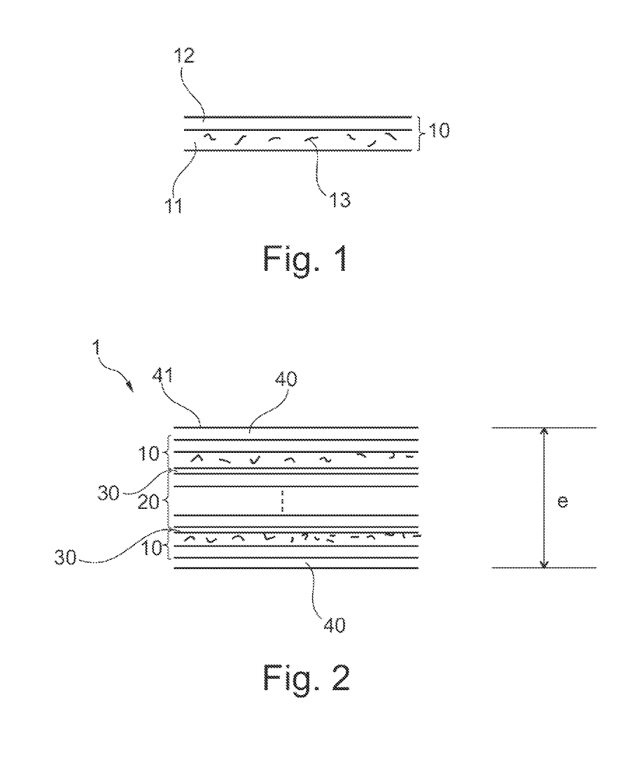

An example of a customizable structure 10 according to the invention has been represented diagrammatically (without observing the actual proportions in the interest of clarity) in FIG. 1.

The structure 10 comprises a fibrous paper sublayer 11 coated with a layer 12 for receiving D2T2 printing or a re-transfer film. The paper sublayer 11 comprises a security element 13, for example in the form of fibers which are fluorescent under UV.

Layer for Receiving Printing

The layer for receiving printing may be deposited on any type of paper sublayer.

The layer for receiving printing according to the invention is non-opaque, preferably transparent, so as not to cover the safety protection(s) of the paper sublayer. Thus, the safety protection(s) of the paper sublayer may be seen by an observer although they are covered by the layer for receiving the printing, by virtue of the non-opaque nature of said layer. Before a lamination step or a calendering step for example, or any other step of applying a specific pressure and/or temperature, the receiving layer is substantially translucent, and then, following this step, the layer becomes substantially transparent owing to the modification of its surface finish which has become more homogeneous and smoother.

Furthermore, by virtue of the non-opacity of the layer for receiving printing, or even its transparency, if required, it is possible to print the paper sublayer by offset printing or by any other means, in particular laser toner or inkjet printing, before depositing the layer for receiving printing.

The layer for receiving printing is supple and flexible and will not degrade the mechanical characteristics of the multilayer structure. Its thickness is, for example, between 5 and 30 μm.

The layer may be deposited directly on a sublayer of raw paper or paper which has been printed, for example by offset printing.

The external surface of the layer for receiving printing is preferably smooth, since the quality of the printing depends on its surface finish. On a multilayer structure in which the customizable surface has been laminated on a body of multilayer structure, the Bendtsen roughness is preferably less than 100 ml/min after lamination. Before lamination the Bendtsen roughness is lower, being for example approximately 900 ml/min.

The layer for receiving printing comprises according to the invention a vinyl polymer, which is in particular nonhalogenated, better still a poly(vinyl ester) and preferably poly(vinyl acetate), for example PVAc known under the trade references Vinamul 6000, Vinamul 9300, Rucoplast HH or Appretan TT.

The layer for receiving printing may consist, by dry weight, of 40% to 80% of vinyl polymer, which is in particular nonhalogenated, better still of poly(vinyl ester) and preferably of PVAc, preferentially between 50% and 70%.

The layer for receiving printing may comprise several vinyl polymers, which are in particular nonhalogenated, preferably in a content by dry weight in the layer for receiving printing of 40% to 80%, preferentially between 50% and 70%.

The layer for receiving printing may advantageously comprise PVAc homopolymer.

The vinyl polymer(s) present in the layer for receiving printing is (are) preferably nonhalogenated.

The layer for receiving printing may also comprise a release agent, such as a wax, in particular a carnauba wax, a paraffin wax, a polyethylene wax, a calcium stearate or PTFE. The release agent has the function of preventing the layer for receiving printing from sticking to the lamination plate used when the customizable structure is laminated on the body of multilayer structure.

Carnauba wax is preferred to paraffin wax, which degrades at 130° C.

The layer for receiving printing may comprise silica. Said silica may in particular improve the offset printing, and the non-adhesion to lamination plates.

The layer for receiving printing may comprise a blend of at least two polymers, each having at least vinyl acetate as monomer, in particular a blend of PVAc homopolymer and of a copolymer at least one of the monomers of which is vinyl acetate and preferably the other monomer of which or at least one of the other monomers of which is an alkene.

The layer for receiving printing may consist, by dry weight, of 40% to 80% of the blend of at least two polymers previously described, in particular of 50% to 70%.

The layer for receiving printing may consist, by dry weight, of 30% to 60% of PVAc homopolymer and of 5% to 40% of the copolymer previously described, in particular of 35% to 50% of PVAc homopolymer and of 12% to 25% of the copolymer.

The layer for receiving printing may consist, on a dry basis, of 60 to 80 parts of PVAc homopolymer and of 20 to 40 parts of the copolymer previously described, in particular of 65 to 75 parts of PVAc homopolymer and of 25 to 35 parts of the copolymer.

The layer for receiving printing may comprise a release agent, in particular wax. The layer for receiving printing may comprise silica.

In particular, the layer for receiving printing may comprise a blend of PVAc homopolymer and of vinyl acetate/ethylene copolymer.

Such a blend is particularly suitable for D2T2 printing in color. It may also be used for D2T2 printing in black or for re-transfer printing.

In the case of the use of such a blend, the release agent may be wax, in particular carnauba wax. The layer for receiving printing may comprise silica. The layer for receiving printing may comprise PVAc homopolymer and a vinyl acetate/ethylene copolymer, a wax and a silica, in particular with a proportion, on a dry basis, of 60 to 80 parts, preferably 65 to 75 parts, of PVAc homopolymer, of 20 to 40 parts, preferably 25 to 35 parts, of ethylene/vinyl acetate copolymer, of 15 to 40 parts, preferably 25 to 35 parts, of wax and of 20 to 50 parts, preferably 30 to 40 parts, of silica.

The PVAc homopolymer may be Makrovil V344 and the ethylene/vinyl acetate copolymer may be Vinamul 3265.

The layer for receiving printing may be applied by pencil coating.

The layer for receiving printing may consist, by dry weight, of 30% to 60% of PVAc homopolymer and of 5% to 40% of the copolymer previously described, in particular of 35% to 50% of PVAc homopolymer and of 12% to 25% of the copolymer.

The layer for receiving printing may consist, on a dry basis, of 60 to 80 parts of PVAc homopolymer and of 20 to 40 parts of the vinyl acetate/ethylene copolymer, in particular of 65 to 75 parts of PVAc homopolymer and of 25 to 35 parts of the vinyl acetate/ethylene copolymer.

The layer for receiving printing may in particular comprise PVAc homopolymer and carnauba wax as release agent, preferably with a proportion of 100 parts (by weight) of PVAc homopolymer and of 12 to 20 parts of carnauba wax, better still of 14 to 18 parts, even better still of 15 and 17, or even approximately 16. The deposition may be carried out in this example with an amount by dry weight, for example, of 5 to 30 g/m², better still 10 to 20 g/m².

The layer for receiving printing may consist, by weight, of 70% to 95% of PVAc, preferentially between 80% and 90%, and of 5% to 30% of release agent, preferentially between 10% and 20% on a dry basis. In the case where the receiving layer comprises an inorganic filler, for example silica, in particular for improving the printability, the layer preferably comprises between 40% and 80% by weight of vinyl polymer, in particular of polyvinyl ester, better still of polyvinyl acetate, even better still between 50% and 70% by weight of polyvinyl ester, in particular polyvinyl acetate.

Unless otherwise indicated, the percentages are by dry weight relative to the total on a dry basis.

The layer for receiving printing may consist of 85 to 115 parts of PVAc, preferentially between 90 and 110 parts, and of 15 to 40 parts of release agent, preferentially between 25 and 35 parts.

The deposition of the layer for receiving printing on the paper sublayer is preferably carried out in an amount of between 5 and 30 g/m², preferentially between 10 and 20 g/m² by dry weight.

The deposition is preferably carried out by means of a coating or printing technique, as indicated above.

The vinyl polymer and the release agent are preferably in aqueous phase, prepared at an acidic or neutral pH with a viscosity adapted by those skilled in the art to the coating technique chosen.

Very good printing results (white density 1.94 on an X-Rite series 500 densitometer) are obtained with, as polymer, Appretan TT (100 parts) (PVAc) mixed with PTFE (2.5 parts) for a deposition of 30 g/m², and with Appretan TT (95 parts) mixed with CaCO₃ (5 parts) for a deposition at 27 g/m² (black density 1.91). The lamination can be carried out without adhesion to the plates.

Paper Sublayer

The fibrous paper sublayer may comprise:
natural fibers, preferably in a content by weight of between 55% and 80%, preferably between 60% and 65%, relative to the total weight of the sublayer,
synthetic fibers, preferably in a content by weight of between 3% and 10%, preferably between 4% and 8%, relative to the total weight of the sublayer.

With regard to synthetic fibers, the paper layer may advantageously comprise same in a content of between 7% and 15% by volume.

The paper sublayer also advantageously comprises:
an inorganic filler, preferably in a content by weight of between 9% and 20%, preferably between 12% and 16%, relative to the total weight of the sublayer,
a binder, in particular a mixture of PVA and of starch or a latex, preferably an acrylic latex, and
a softener, in particular glycerol, urea, sodium nitrate or a mixture thereof.

The triple combination of synthetic fibers, a binder and also a softener advantageously makes it possible to confer on the sublayer improved elasticity, flexibility and double folding endurance properties.

The presence of an inorganic filler advantageously makes it possible to confer on the sublayer printability properties, in particular offset printability properties.

Unless otherwise mentioned, all the contents by weight of the compounds included in the paper layer are given by dry weight.

The thickness of the paper sublayer is, for example, between 80 and 200 μm.

Natural Fibers

The natural fibers may be present in the paper sublayer in the form of a mixture of long natural fibers (conifer-derived) and short natural fibers (broad-leaved-tree-derived).

The long natural fibers may be used to improve the mechanical strength and the short natural fibers may be used to confer opacity.

In one exemplary embodiment, the proportion by weight of short natural fibers, within the sublayer, is less than or equal to the proportion by weight of long natural fibers. Thus, at least 50% by weight of the natural fibers may be long natural fibers. Preferably, at least 80% by weight of the natural fibers are long natural fibers.

The natural fibers may be wholly or partly formed from cellulose-based fibers, in particular may be all cellulose-based fibers.

Synthetic Fibers

The synthetic fibers may be chosen from rayon fibers, in particular staple-fiber or viscose, or fibers of a thermoplastic material, in particular of a polyamide, of a polyester, of a polyolefin and/or a mixture of such fibers.

The content by weight of synthetic fibers in the paper sublayer may be evaluated by a three-dimensional measurement by stereology on two-dimensional sections using a scanning electron microscope.

Several images in section may be acquired, in the direction of operation of the paper machine (SM) and in the cross direction (ST).

The number of synthetic fibers intercepted by the section for each image is counted for each paper direction, namely Nₛₜ and Nₛₘ. The average number of synthetic fibers in the paper is calculated by N=\sqrt{Nₛₜ×Nₛₘ}.

The total length L of paper counted is given by the sum of the lengths of the images counted.

The number of fibers per linear meter of paper is given by

$${N}_{ml} = \frac{N}{L} .$$

The weight of synthetic fibers per square meter, w, is calculated using the titer count (or weight per unit length) T of the synthetic fibers, expressed in decitex (weight in grams of 10 000 m of fibers) and Nₘ₁ using the following formula:

$$w = ( \frac{π}{2} ) \times {N}_{ml} \times T .$$

The synthetic fiber content is obtained by dividing this weight by the grammage of the fibrous external layer. Preferably, the number of images is sufficient to count at least 400 synthetic fibers, in order to reduce the inaccuracy of the method.

In one exemplary embodiment, at least 50% by weight of the synthetic fibers may be polyamide fibers.

The synthetic fibers may have an average length greater than 4 mm, for example than 6 mm.

The synthetic fibers may have an average length of 6 mm.

The average diameter of the synthetic fibers may be between 0.9 and 4.2 dtex, for example between 0.9 and 3.3 dtex, better still between 1.2 and 1.7 dtex.

Inorganic Filler

The inorganic filler may be chosen from silica, sodium silicates and aluminosilicates, carbonates, in particular calcium carbonate, talc, kaolin, alumina hydrate, titanium dioxide and mixtures thereof.

The paper sublayer may thus simultaneously comprise silica, sodium aluminosilicate and titanium dioxide, as inorganic filler.

The silica and the sodium aluminosilicate may be used for printability, and the titanium dioxide for opacity and whiteness.

The paper sublayer may comprise silica in a content by weight of between 1% and 5%, preferably between 2% and 3%, relative to the total weight of the sublayer.

The sublayer may comprise sodium aluminosilicate, for example having the reference Zeolex®, in a content by weight of between 4% and 9%, preferably between 5% and 7%, relative to the total weight of the sublayer.

The sublayer may comprise titanium dioxide in a content by weight of between 2% and 9%, preferably between 4% and 7%, relative to the total weight of the sublayer.

Binder and Softener

The binder may be advantageously chosen from thermoplastic polymers having a glass transition temperature Tg (measured according to standard ISO 11357) of less than or equal to +20° C., better still less than or equal to 10° C., to provide flexibility.

In one exemplary embodiment, the fibers of the paper sublayer are bound with a mass-precipitated binder, the binder being, for example, chosen from polymers having a Tg of less than or equal to −10° C., preferably being chosen from acrylic polymers.

In one exemplary embodiment of the invention, the binder is introduced into the sublayer by surfacing, the binder being chosen in this case, for example, from polymers having a Tg of less than or equal to +10° C., the binder comprising, for example, a natural binder, in particular starch, or a synthetic binder, in particular polyvinyl alcohol or an acrylic styrene polymer, for example having a Tg of around 7° C.

The binder advantageously comprises a thermoplastic material, the amount thereof being adjusted so as to obtain in the coating a concentration of this thermoplastic material of less than or equal to 20 g/m² on a dry basis, better still less than or equal to 10 g/m² on a dry basis, it being possible for the binder to comprise a polymer or a copolymer of acrylic styrene-butadiene, acrylic styrene or vinyl nature.

The binder may also be chosen from latexes. Preferably, the binder is chosen from acrylic, styrene-butadiene or butadiene latexes and more preferably, for reasons of durability, in particular resistance to UV and resistance to aging, from acrylic latexes.

The binder may also be chosen from PVA, starch and mixtures thereof, preferably a mixture of PVA and starch.

The binder may be present in the paper sublayer in a content by weight of between 3% and 15%, preferably between 7% and 12%.

The binder may be combined with a softener. The softener is a compound which makes it possible to lubricate the individual fibers in the fibrous network that constitutes the paper; it may be a surfactant product. Such a softener used in the manufacture of paper may have the effect of giving the paper a high elasticity. The softener may be chosen from glycerol, the urea/sodium nitrate mixture, sorbitol, or combinations thereof.

The softener may be present in the sublayer in a content by weight of between 2% and 15%, in particular between 2% and 12%, preferably between 7% and 10%.

Use may be made of the urea/sodium nitrate mixture as softener, preferably with a

$$\frac{urea}{sodium nitrate}$$

weight ratio of between 1 and 5, preferably between 1.5 and 3.

It may be advantageous for the ratio between the content by weight of binder and the content by weight of inorganic filler, in the sublayer, to be between 0.25 and 1.5, preferably between 0.5 and 0.75.

The sublayer may have a grammage of between 90 and 175 g/m², for example between 100 and 150 g/m².

The sublayer according to the invention may comprise security elements of any type known to those skilled in the art.

Security Elements

Among the security elements that may be incorporated into the paper sublayer, some are detectable by eye, in daylight or in artificial light, without the use of a particular apparatus. These security elements comprise, for example, colored fibers or planchettes, or totally or partially printed or metalized threads. These security elements are termed first-level security elements.

Other types of additional security elements are detectable only using a relatively simple apparatus, such as a lamp which emits in the ultraviolet (UV) or infrared (IR) range. These security elements comprise, for example, fibers, planchettes, strips, threads or particles. These security elements may or may not be visible to the naked eye, being for example luminescent under illumination from a Wood lamp emitting in a wavelength of 365 nm. These security elements are termed second-level security elements.

Other types of security elements require, for their detection, a more sophisticated detection apparatus. These security elements are, for example, capable of generating a specific signal when they are subjected, optionally simultaneously, to one or more external excitation sources. The automatic detection of the signal makes it possible to authenticate the document, as required. These security elements comprise, for example, tracers that are in the form of active materials, particles or fibers, capable of generating a specific signal when these tracers are subjected to an optronic, electrical, magnetic or electromagnetic excitation. These security elements are termed third-level security elements.

Reagents may also be incorporated into the sublayer; they may, for example, be chemical or biochemical forgery-preventing and/or authenticating and/or identifying reagents which may in particular react respectively with at least one forgery and/or authenticating and/or identifying agent.

It is known to be possible to forge D2T2 printing with acetone. When printing is carried out on the customizable structure by D2T2 printing in black and the printing is effaced using acetone, the layer for receiving printing is degraded at the same time, when said layer is based on poly(vinyl acetate). Thus, during reprinting, it is noted that the patterns are not as clear and that the black resembles more closely gray. Likewise, there is a decrease in the sharpness between the patterns, or even at least partial disappearance of the patterns made by D2T2 printing in color and the patterns reprinted by D2T2 printing in color after effacing using acetone.

The paper sublayer and/or the layer for receiving printing may advantageously contain a reagent that reacts with acetone, such as nigrosine black. If a piece of data printed by D2T2 is effaced from the card using acetone, this reagent irreversibly turns a different color, thereby demonstrating the forgery visually. This reagent may be introduced in an amount of between 0.001% and 0.1% by weight relative to the total on a dry basis.

Alternatively, a coated protective layer (overlay) or a protective film (laminate) may be deposited on the card (after D2T2 printing, but still in the D2T2 printing machine).

It may be particularly advantageous for the paper sublayer to comprise a level-1 or level-2 security element, visible to the naked eye, optionally under UV or IR illumination, in order to take advantage of the fact that the layer for receiving printing is non-opaque.

Manufacture of the Paper Sublayer

The paper sublayer may be produced on a conventional Fourdrinier-table or cylinder-mold paper machine, said machine making it possible to convey all the securing means well known in the field of security papers, namely security documents (check, passport papers, tax disks, etc.), or banknotes.

The manufacture of the sublayer may comprise the steps consisting in:

a) providing a fibrous suspension comprising the natural fibers, then

b) adding the synthetic fibers to said fibrous suspension so as to obtain a fibrous composition, and

c) adding the inorganic filler to said fibrous composition or to said fibrous suspension.

It is possible for the fibrous suspension to be refined before step b).

The process described above may also comprise, after addition of the synthetic fibers, the addition of a composition comprising the abovementioned binder, for example by impregnation, surfacing, spread-coating and/or coating. In this case, the abovementioned inorganic filler may be included in said composition and may thus be added during the impregnation, surfacing, spread-coating and/or coating. Any known process or device can be used for this, in particular an impregnator, a size press, a film press, an air-knife or knife coater, a curtain coater, a Champion coater, a helio coater, or a film transfer coater, for example such as a “Twin-HSM” coater from the company BTG.

The fibrous composition obtained after either of steps b) and c) may be drained, pressed and dried according to the common paper-making process, for example before addition of the binder.

The composition comprising the binder is preferably added by means of an impregnator or a size press.

Properties of the Customizable Structure

The paper sublayer coated with the layer for receiving printing according to the invention does not exhibit a marking on folding. Indeed, when the two edges along the length of an ID-1 card comprising a customizable structure according to the invention, in accordance with standards ISO 7810 and ISO 10373 (for example a card as described in the examples hereinafter), are brought into contact by folding, the customizable structure exhibits neither an irreversible mark nor fold nor deformation. Such a property is not confirmed by an entirely plastic ID-1 card which will break or will be irreversibly marked even before its two edges are in contact.

At least two of the mechanical characteristics presented hereinafter, preferably all three, are thus preferably confirmed by a customizable structure according to the invention.

Young's Modulus

The Young's modulus is determined according to standard ISO 1924 “Paper and board—Determination of tensile properties” (“Part 2: constant rate of elongation method”).

The paper sublayer coated with the coat for receiving printing may have a Young's modulus of less than 1500 MPa, preferably less than 900 MPa.

Double Folding Endurance

The double folding endurance is determined according to standard ISO 5626 “Paper—Determination of folding endurance”.

The paper sublayer coated with the layer for receiving printing may have a double folding endurance (Lhommargy measurement) greater than 2000, preferably greater than 5000.

Elongation

The elongation is determined according to standard ISO 1924 “Paper and board—Determination of tensile properties” (“Part 2: constant rate of elongation method”).

The paper sublayer coated with the layer for receiving printing may exhibit an elongation in the direction of operation (in the direction of manufacture on the paper machine) greater than 5%, preferably greater than 6%.

Body of Multilayer Structure (in Particular Card)

The card body may comprise one or more paper and/or plastic layers. The card body may house a contact, contactless or dual-interface electronic chip.

It may prove to be advantageous for the card body to comprise at least one paper layer.

All of the layer(s) of the card body may be paper layers.

At least two layers of the card body may be interconnected with one another via an adhesive.

This paper layer preferably comprises cellulose fibers and synthetic fibers, and may have the same formulation as the paper sublayer of the customizable structure.

The card body may comprise one or more level-1, level-2 or level-3 security elements.

In the presence of an electronic chip in the card body, the thickness of said chip may be at least partly compensated for by a paper layer which has a cavity or a hole into which the chip extends.

The card body may have a monolayer or multilayer structure.

The thickness of the card body may be 460±80 μm.

The card body may receive a customizable structure according to the invention on both of its faces or on just one of the faces.

Adhesive

The card body and/or the paper sublayer may comprise an adhesive coating on at least one face. A heat-activated adhesive or a pressure-sensitive adhesive may be used. This adhesive may be chosen from acrylics, acrylonitriles, blocked isocyanates, thermoplastics (PE, PETg, PVC, etc.), or mixtures thereof. Preferentially, the adhesive will be chosen from heat-activated adhesives comprising a polymer chosen from polyurethane, polyethylene, acrylic or vinyl polymers, for example polyvinyl acetate, and blends thereof.

The assembly of the card body and of the sublayer may be carried out using lamination techniques, in particular hot-lamination techniques, known to those skilled in the art.

The lamination parameters are preferably between 100 and 150° C., 50 and 200 N/cm² and 10 to 45 minutes.

A removable PC (polycarbonate) release layer may be superimposed, during the lamination, on the layer for receiving printing so as not to stick to the lamination plate. This PC layer is then removed.

### EXAMPLES

An example of a card 1 produced in accordance with the invention has been represented in FIG. 2.

The card 1 comprises a card body 20, which may be assembled by means of heat-activated adhesive layers 30 comprising customizable structures 10. The body of multilayer structure may itself be formed on these external layers of thermoplastic materials (PE, PETg, PVC, etc.) acting as adhesive.

The customizable structures 10 may be protected after printing, where appropriate, with a protective film 40, at least one of which may bear a hologram 41.

The total thickness e of the card may comply with standard ISO 7810.

The card body and the customizable structures may be produced according to one of examples 1 to 5 given hereinafter.

### Example 1

### PVC Card without RFID Device

The card body is composed of six layers of PVC 100 μm thick (to obtain the desired standardized thickness) from the company Galazzi.

Two customizable structures according to the invention are placed respectively on either side of the card body so as to define the external surfaces of the card.

The paper sublayer comprises, as security elements, Hilite® fluorescent particles and security fibers.

The sublayer is an AWCEL paper as considered in example 1 of document WO 2012/014112. The layer for receiving printing is a mixture of PVAC (100 parts), for example Appretan TT, mixed with PTFE (2.5 parts) for a deposit of 30 g/m². This layer is applied by air-knife coating.

The assembly formed from the card body and the customizable structures is hot-laminated on a plate press at temperatures of about 130° C., under a pressure of 80 bar, for 15 min.

The resulting card is a card which has substantially the same mechanical properties as a conventional PVC card, and which is also customizable by D2T2 printing. Furthermore, it is made secure by the securing fibers and the Hilite® particles.

### Example 2

### Secure Paper Card

The card body is composed of three layers of AWSLA paper as described in example 1 (first flexible support) of the publication WO 2009/1007659, each 200 μm thick, coated with heat-activated adhesive of acrylic nature.

A customizable structure according to the invention is then placed on each side of the card body. The customizable structure is the same as in example 1, the only difference being that the paper sublayer comprises, as security elements, UV-fluorescent security fibers and a taggant introduced in bulk into the paper.

The assembly is then hot-laminated at temperatures of about 140° C., at a pressure of 80 bar, for 15 min.

The resulting card is termed “100% paper”, more flexible than a conventional plastic card, but exhibiting no irreversible deformation after bending tests.

This card is of standardized thickness and is made secure by the presence of the UV-fluorescent fibers and the possibility of detecting the abovementioned taggant using a specific detector.

The customization (information about the person carrying the card, such as name, address, etc.) is produced by D2T2 printing on an Evolis machine, for example sold under the reference Peeble.

### Example 3

### RFID Card

The card body comprises a monolayer Paperlam® structure as described in the publication WO 2011/135497 A1, formed with a layer of AWSLA paper as disclosed in application WO 2009/007659 A2 (example 1), 300 μm thick, coated with a heat-activated adhesive of polyurethane type. The card body houses an RFID module MOB4 chip, for example having the reference MCC8, sold by the company Infineon, and comprises an antenna integrated by insertion into the paper.

A layer of AWSLA paper 130 μm thick and coated with the same heat-activated adhesive is placed on either side of the monolayer Paperlam® structure.

Two customizable structures according to the invention are placed respectively on either side of the card body. The paper sublayer has the same composition as in example 1, the only difference being that it comprises, as security elements, Hilite® fluorescent particles, security fibers which are fluorescent under UV, planchettes and also a “Hi Co” or “Low Co” magnetic strip.

The layer for receiving printing has the same formulation as in example 1.

The assembly is laminated on a plate press at temperatures of about 130° C., under a pressure of 80 bar, for 15 min.

The resulting card is termed “eCard”, being made secure by the RFID chip and identifiable by virtue of the presence of the UV fibers, Hilite® particles and planchettes.

The card may be supplied with the paper sublayer preprinted by offset printing, the customization of the card being carried out by D2T2 printing on a machine of the Securion brand sold by the company Evolis, which also customizes the magnetic strip and affixes a holographic protective external film.

The card is of standard thickness.

### Example 4

### RFID Card

The card body consists of a bilayer Paperlam® structure, composed of a first layer of AWSLA paper 130 μm thick, coated with heat-activated adhesive, and of a second layer of AWSLA paper 200 μm thick, also coated with a heat-activated adhesive. The card body houses an RFID module chip and an antenna integrated by insertion into the paper.

Two layers of PETg 120 μm thick are placed respectively on either side of this Paperlam® structure.

A layer of AWCEL paper 150 μm thick is placed as external layer on one side and the other side receives a customizable structure according to the invention, having the same formulation as in example 1.

The layer of AWCEL paper, like the paper sublayer of the customizable structure, comprises Hilite fluorescent particles and security fibers which are fluorescent under UV.

An electronic contact module, as encountered in bank cards, is inserted at the surface of the card by perforation of the customizable structure and of the PETg layer.

The resulting card is termed “eCard”, being made secure by the RFID chip and by the contact module, and identifiable by virtue of the UV fibers and the Hilite® particles.

The paper sublayer may be preprinted by offset printing before the layer for receiving printing is deposited and the card may be customized by inkjet printing on the face opposite the contact module.

The number of the card is provided by D2T2 printing on the layer for receiving printing on a DTC550 machine sold by the company HID which makes it possible, in addition, to apply a protective film on the face customized by D2T2 printing.

### Example 5

The card body comprises a PET “inlay” layer with an etched antenna made of aluminum and an electronic chip termed “flip chip”. This chip is housed in a layer of AWSLA paper 130 μm thick, coated with a heat-activated adhesive, so as to compensate for the thickness of the chip.

The card comprises respectively, on either side of the body thereof, two customizable structures according to the invention. Within each customizable structure, the paper sublayer comprises fibers which are visible under UV.

The paper sublayer and the layer for receiving printing have the same formulations as in example 1.

The assembly of the customizable structure to the card body is carried out using a heat-activated adhesive. The whole assembly is laminated on a roll press at a temperature of about 120° C.

The resulting structure is offset printed and then cut to the desired format.

The thickness is about from 350 to 400 μm and the card may be used as a loyalty card, a ski pass, an event ticket or the like.

In the case of an event ticket, the customization of the event, for example the ticket number and a 2D QR code, is carried out by D2T2 printing.

### Example 6

The card body consists of a bilayer Paperlam® structure, composed of a first layer of AWSLA paper 130 μm thick, coated with heat-activated adhesive, and of a second layer of AWSLA paper 200 μm thick, also coated with a heat-activated adhesive. The card body houses an RFID module chip and an antenna integrated by insertion into the paper.

Two PETg layers 120 μm thick are placed respectively on either side of this Paperlam® structure.

A layer of AWCEL paper 150 μm thick is placed as external layer on one side and the other side receives a customizable structure according to the invention. The customizable structure is composed of a sublayer of AWCEL paper with a layer for receiving printing which is composed of a blend of two polymers each having as monomer at least vinyl acetate, preferably a PVAc homopolymer and an ethylene/vinyl acetate copolymer, such as Makrovil V344 (70 parts) and Vinamul 3265 (30 parts), of a wax (30 parts) and also of a silica (35 parts) for a deposit of 20 g/m² for improving offset printing in particular. This layer is applied by pencil coating.

The layer of AWCEL paper, like the paper sublayer of the customizable structure, comprises Hilite fluorescent particles and security fibers which are fluorescent under UV.

The paper sublayer may be offset-preprinted before the layer for receiving printing is deposited.

A layer for receiving printing may be offset-printed.

The card may be customized by D2T2 on the customizable face according to the invention and by inkjet on the face opposite said face.

The number of the card is provided by D2T2 printing on the layer for receiving printing on a Securion machine sold by the company Evolis which makes it possible, in addition, to apply a protective film on the customized face by D2T2 printing.

The assembly formed from the card body, the PETg layers, the layer of AWCEL paper and the customizable structure is hot-laminated on a plate press at temperatures of about 130° C., under a pressure of 80 bar, for 15 min.

The resulting card is a card which has substantially the same mechanical properties as a conventional PVC card, and which is also customizable by D2T2 printing. Furthermore, it is made secure by the security fibers and the Hilite® particles. The card is particularly suitable for D2T2 printing in color.

The following table gives the result of tests carried out with the card of example 4.

| Test | Standard | Conclusion |
|---|---|---|
| Thickness | ISO 7810 | OK |
| Bending | ISO 10373-1 | OK |
| Creasing test | Derived from | OK |
| | standard | |
| | ISO 1519 | |
| Scotch test | Derived from | OK |
| | standard Finat 21 | |
| 48 h Xenotest | ISO 105B02 | OK |
| Dry oven 72 h 105° C. | ISO 5630-3 | OK |
| Climatic chamber 72 h 80° C. 65% RH | ISO 5630-3 | OK |
| Test* for dimensional stability and | ISO 10373-1 | OK |
| deformation of the card according to the | | |
| temperature and humidity conditions | | |
| (−35° C. 1 h-+50° C. 1 h) | | |
| Adherence test* | ISO 10373-1 | OK |
| (40° C.-50% RH - pressure 2.5 kPa) | | |

*The test is carried out in a climatic chamber, under the conditions specified.

Of course, the invention is not limited to the examples described.

The card, and in particular the card body, may have other structures.

The expression “comprising a” should be understood to be synonymous with “comprising at least one”, unless otherwise specified.

1. A structure that is customizable by thermal transfer printing, in particular D2T2 or re-transfer, in particular for a multilayer structure of secure card type, the customizable structure comprising:
a layer of a non-opaque material for receiving thermal transfer printing, preferably comprising a vinyl polymer, which is in particular nonhalogenated, better still a polyvinyl ester, more preferably polyvinyl acetate (PVAc),
a fibrous paper sublayer, comprising at least one security element integrated into the paper and/or placed at the surface of the fibrous sublayer.

2. A structure that is customizable by thermal transfer printing, in particular D2T2 or re-transfer, in particular for a multilayer structure of secure card type, the customizable structure comprising:
a layer of a non-opaque material for receiving thermal transfer printing, preferably comprising a vinyl polymer, which is in particular nonhalogenated, better still a polyvinyl ester, more preferably polyvinyl acetate (PVAc),
a fibrous paper sublayer, having received in the fluid state the layer for receiving printing, and preferably comprising at least one security element integrated in the paper and/or placed at the surface of the fibrous sublayer.

3. The structure as claimed in claim 1, the layer for receiving printing comprising between 70% and 95% by weight of vinyl polymer, in particular of polyvinyl ester, better still of polyvinyl acetate, better still between 80% and 90% by weight of polyvinyl ester, better still of polyvinyl acetate.

4. The structure as claimed in claim 1, the layer for receiving printing being present in an amount of between 5 and 30 g/m², better still between 10 and 20 g/m².

5. The structure as claimed in claim 1, the layer for receiving printing comprising a release agent, preferably in a content of 5% to 30% by weight, better still 10% to 20% by weight, relative to the total dry weight of this layer.

6. The structure as claimed in claim 5, the release agent being chosen from waxes, in particular carnauba wax, paraffin wax, polyethylene wax, a calcium stearate and PTFE.

7. The structure as claimed in claim 1, the layer for receiving printing being printed by thermal transfer, in particular D2T2 or re-transfer.

8. The structure as claimed in claim 1, the paper sublayer comprising a reagent which produces a color reaction in the presence of acetone, in particular nigrosine black.

9. The structure as claimed in claim 1, the paper sublayer being printed, in particular by offset, laser toner or inkjet printing.

10. The structure as claimed in claim 1, the paper sublayer comprising an inorganic filler.

11. The structure as claimed in claim 1, the paper sublayer comprising synthetic fibers, preferably in a content of between 7% and 15% by volume.

12. The structure as claimed in claim 1, the paper sublayer comprising a binder, in particular a latex, preferably an acrylic latex.

13. The structure as claimed in claim 1, the paper sublayer comprising a softener, in particular a urea/nitrate mixture.

14. The structure as claimed in claim 1, the paper sublayer comprising a security element, preferably chosen from luminescent agents, in particular UV-fluorescent agents, in particular in the form of fibers and/or of pigment.

15. The structure as claimed in claim 1, the paper sublayer comprising a magnetic security element.

16. The structure as claimed in claim 1, the paper sublayer comprising planchettes as security element.

17. The structure as claimed in claim 1, the thickness (e) of the card being equal to 760 μm plus or minus 80 μm.

18. The structure as claimed in claim 1, the layer for receiving printing being covered with a protective film.

19. The multilayer structure as claimed in claim 18, the protective film bearing a diffractive structure, in particular a hologram.

20. The structure as claimed in claim 1, the layer for receiving printing comprising PVAc homopolymer, in particular a mixture with carnauba wax as release agent.

21. The structure as claimed in claim 1, the layer for receiving printing comprising a blend of at least two polymers, each having at least vinyl acetate as monomer, in particular a blend of PVAc homopolymer and of a copolymer, one of the monomers of which is vinyl acetate and preferably the other monomer of which or at least one of the other monomers of which is an alkene.

22. The structure as claimed in claim 1, the layer for receiving printing comprising an ethylene/vinyl acetate copolymer, in particular blended with PVAc homopolymer.

23. The structure as claimed in claim 1, the layer for receiving printing comprising at least one inorganic filler, in particular silica.

24. The structure as claimed in claim 23, the layer for receiving printing comprising between 40% and 80% by weight of vinyl polymer, in particular of polyvinyl ester, better still of vinyl acetate, better still between 50% and 70% by weight of polyvinyl ester, in particular polyvinyl acetate.

25. A multilayer structure, in particular of secure card type, comprising:
a customizable structure as defined in claim 1,
a body of multilayer structure to which the customizable structure is attached.

26. The multilayer structure as claimed in claim 25, comprising a layer of adhesive, in particular heat-activated adhesive, between the body of the card and the customizable structure.

27. The multilayer structure as claimed in claim 26, the adhesive being chosen from polyurethanes, acrylics, acrylonitriles, blocked isocyanates, thermoplastics (PE, PETg, PVC, etc.), or mixtures thereof.

28. The multilayer structure as claimed in claim 25, comprising one or more paper layers.

29. The multilayer structure as claimed in claim 25, the card body comprising an electronic chip, in particular an RFID chip.

30. A card comprising the multilayer structure as claimed in claim 25, which is in particular of the identity card, social security card, driver's license, access card, border crossing card, loyalty card, playing card, means of payment, gift token or voucher, travel pass or membership card type.

31. A process for manufacturing a customizable structure as defined in claim 1, wherein the structure that is customizable by thermal transfer printing is produced by depositing, in the fluid state, the layer for receiving printing on the paper sublayer.

32. The process as claimed in claim 31, the depositing of the layer for receiving printing being carried out online, in particular by air-knife, reverse roll or roll flex coating, or offline, in particular by Champion, roll flex, reverse roll or air-knife coating or by means of a printing technique, in particular by photogravure, screen printing or flexography.

33. The process as claimed in claim 31, the customizable structure being covered with a release film during lamination thereof with a body of multilayer structure.

34. The process as claimed in claim 31, wherein the customizable structure receives offset printing before receiving thermal transfer printing.

35. The process as claimed in claim 31, the paper sublayer being printed by offset printing before receiving the layer for receiving thermal transfer printing.

36. The process as claimed in claim 31, the layer for receiving printing being printed by thermal transfer, in particular D2T2, in particular with a black or colored monochrome ink or with polychrome inks.

37. The process as claimed in claim 31, the customizable structure being hot-laminated on the card body, in particular at a temperature greater than or equal to 100° C.
